(19) United States
(12) Patent Application Publication
(10) Pub. No.: US 2020/0326478 A1
(43) Pub. Date: Oct. 15, 2020

(54) LIGHT RECEIVING DEVICE AND DIRECTIONAL LIGHT GUIDE BOARD

(71) Applicant: NEC Corporation, Tokyo (JP)

(72) Inventors: Satoshi KYOSUNA, Tokyo (JP); Koya TAKATA, Tokyo (JP); Fujio OKUMURA, Tokyo (JP)

(73) Assignee: NEC Corporation, Tokyo (JP)

(21) Appl. No.: 16/955,235

(22) PCT Filed: Dec. 20, 2017
(86) PCT No.: PCT/JP2017/045624

§ 371 Date: Jun. 18, 2020

(51) Int. Cl. G02B 6/26; H04B 10/69

(52) U.S. Cl. CPC G02B 6/26; H04B 10/69

(57) ABSTRACT

A light receiving device is provided with: a lens; a directional light guide board including at least a light collection area, a light guide area and an exit end from which the light guided through the light guide area goes out; and a light receiver that is arranged with the light receiving part thereof facing the exit end and that receives the light going out from the exit end and converts the received light to an electric signal, wherein the directional light guide board comprises: a transparent light guide part that guides the light incident on the light collection area toward the exit end; and a directional reflection part in which formed is a reflection structure having at least one reflective surface for reflecting the light, incident from a first surface, toward the exit end in such a manner that satisfies a total reflection condition.

### TECHNICAL FIELD

The present invention relates to a light receiving device that receives signal light. Particularly, the present invention relates to a light receiving device and a directional light guide board that receive signal light used in an optical space communication.

### BACKGROUND ART

In an optical space communication, signal light (hereinafter, also referred to as spatial light) propagating in space is mutually transmitted and received without using a medium such as an optical fiber. In order to receive spatial light propagating in space in a spreading way, a largest possible light collection lens is needed. In the optical space communication, a photodiode having small capacitance is needed in order to perform high-speed communication. In an environment in which positions of agents that mutually transmit and receive signal light change relative to each other, it may not be possible to predict which direction the signal light arrives from.

PTL 1 discloses an imaging device having a focus detection optical system. The device in PTL 1 divides a light flux into a plurality of light fluxes by arranging a holographic optical element on an imaging lens optical path, and guides at least one of the divided light fluxes to the focus detection optical system.

PTL 2 discloses an internal reflection device using a holographic optical element for a free-space optical communication system. The device in PTL 2 directs, at an angle, signal light having a particular wavelength toward one surface of the element, thus converges the signal light toward a convergence point by causing the signal light to propagate between a front surface and a back surface of the element by internal total reflection, and receives the signal light by a light detection circuit disposed at the convergence point.

### CITATION LIST

### Patent Literature

[PTL 1] Japanese Unexamined Patent Application Publication No. H04-147108

[PTL 2] Japanese Unexamined Patent Application Publication (Translation of PCT Application) 2004-531978

### SUMMARY OF INVENTION

### Technical Problem

According to the device in PTL 1, a light source conversion device can be small-sized by guiding a part of light collected by a lens to a photoelectric conversion device. However, the device in PTL 1 does not receive, in the photoelectric conversion device, most of light collected by the lens, and therefore, has a problem that a photoelectric conversion device having high sensitivity needs to be used. When the photoelectric conversion device is disposed at an image formation position of an image formation lens, most of light collected by the lens can be received by the photoelectric conversion device, but in that case, there is a problem that the device becomes large-sized.

According to the device in PTL 2, signal light arriving from a forward direction can be efficiently received by enlarging a light collection area of the device. However, an arrival direction of signal light used in the optical space communication is not limited to one direction. Further, a diffraction direction by the holographic optical element is limited to a given direction. Specifically, the device in PTL 2 has a problem that it is not possible to efficiently receive signal light when the signal light arrives from various angles.

An object of the present invention is to provide a light receiving device that solves the problems described above, and can efficiently receive signal light even in a situation where an arrival direction of the signal light used in an optical space communication is not uniquely determined.

### Solution to Problem

A light receiving device according to one aspect of the present invention includes: a lens; a directional light guide board including at least a light collection area which is disposed in such a way as to face a light collection surface of the lens, and which light collected by the lens enters, a light guide area through which the light entering the light collection area is guided, and an exit end from which the light guided through the light guide area exits; and a light receiver that is disposed with a light receiving unit thereof directed to the exit end, and that receives the light exiting from the exit end and then converts the received light into an electric signal, wherein the directional light guide board includes a transparent light guide unit that includes a first surface facing the light collection surface of the lens, and a second surface facing the first surface, and guides the light entering the light collection area toward the exit end, and a directional reflection unit which is disposed on the second surface of the transparent light guide unit, and in which a reflection structure having at least one reflection surface that reflects, toward the exit end, the light entering from the first surface is formed in such a way as to satisfy a total reflection condition.

A directional light guide board according to one aspect of the present invention includes at least a light collection area which is disposed in such a way as to face a light collection surface of a lens, and which light collected by the lens enters, a light guide area through which the light entering the light collection area is guided, and an exit end from which the light guided through the light guide area exits, and the directional light guide board further includes: a transparent light guide unit that includes a first surface facing the light collection surface of the lens, and a second surface facing the first surface, and guides, toward the exit end, the light entering the light collection area from the first surface; and a directional reflection unit which is disposed on the second surface of the transparent light guide unit, and in which a reflection structure having at least one reflection surface that reflects, toward the exit end, the light entering from the first surface is formed.

### Advantageous Effects of Invention

The present invention is able to provide a light receiving device that solves the problem described above, and can efficiently receive signal light even in a situation where an arrival direction of signal light used in an optical space communication is not uniquely determined.

### BRIEF DESCRIPTION OF DRAWINGS

FIG. 1 is a sectional view illustrating a configuration of a light receiving device according to a first example embodiment of the present invention.

FIG. 2 is a top view of the light receiving device according to the first example embodiment of the present invention.

FIG. 3 is a conceptual diagram for describing light receiving directivity of a light receiver of a light receiving device according to each example embodiment of the present invention.

FIG. 4 is a conceptual diagram for describing light guiding by a directional light guide unit of the light receiving device according to the first example embodiment of the present invention.

FIG. 5 is a conceptual diagram for describing light guiding by the light receiving device according to the first example embodiment of the present invention.

FIG. 6 is a conceptual diagram illustrating a situation where signal light entering the light receiving device according to the first example embodiment of the present invention from multiple directions is guided to the light receiver.

FIG. 7 is a sectional view illustrating a configuration of a modification example of the light receiving device according to the first example embodiment of the present invention.

FIG. 8 is a sectional view illustrating a configuration of another modification example of the light receiving device according to the first example embodiment of the present invention.

FIG. 9 is a conceptual diagram for describing light receiving according to a related technique.

FIG. 10 is a sectional view illustrating a configuration of a light receiving device according to a second example embodiment of the present invention.

FIG. 11 is a conceptual diagram illustrating a situation where signal light entering the light receiving device according to the second example embodiment of the present invention is guided to a light receiver.

FIG. 12 is a sectional view illustrating a configuration of a light receiving device according to a third example embodiment of the present invention.

FIG. 13 is a top view illustrating the configuration of the light receiving device according to the third example embodiment of the present invention.

FIG. 14 is a conceptual diagram illustrating a configuration of a color filter of the light receiving device according to the third example embodiment of the present invention.

FIG. 15 is a top view illustrating a configuration of a light receiving device according to a fourth example embodiment of the present invention.

FIG. 16 is a conceptual diagram illustrating a configuration of a color separation unit of the light receiving device according to the fourth example embodiment of the present invention.

FIG. 17 is a top view illustrating a configuration of a modification example of the light receiving device according to the fourth example embodiment of the present invention.

FIG. 18 is a conceptual diagram illustrating a configuration of a color separation unit of a modification example of the light receiving device according to the fourth example embodiment of the present invention.

FIG. 19 is a top view illustrating a configuration of a light receiving device according to a sixth example embodiment of the present invention.

FIG. 20 is a sectional view illustrating a configuration of a light receiving device according to a seventh example embodiment of the present invention.

FIG. 21 is a top view illustrating a configuration of a light receiving device according to the seventh example embodiment of the present invention.

FIG. 22 is a sectional view illustrating a configuration of a modification example of the light receiving device according to the seventh example embodiment of the present invention.

FIG. 23 is a conceptual diagram for describing an application example of the light receiving device according to each example embodiment of the present invention.

FIG. 24 is a conceptual diagram for describing an application example of the light receiving device according to each example embodiment of the present invention.

FIG. 25 is a conceptual diagram for describing an application example of the light receiving device according to each example embodiment of the present invention.

FIG. 26 is a conceptual diagram for describing an application example of the light receiving device according to each example embodiment of the present invention.

### EXAMPLE EMBODIMENT

Example embodiments of the present invention will be described below by use of the drawings. Technically preferable limitation is given to the example embodiments described below in order to implement the present invention, but does not limit the scope of the invention to the following. Unless there is a particular reason, the same reference sign is assigned to a similar part in all the drawings used for description of the example embodiments below. Moreover, in the example embodiments below, repeated description may be omitted in relation to a similar configuration or operation. A direction of an arrow in the drawings indicates one example, and does not limit a direction of a signal between blocks.

A line indicating travel of light in the drawings is conceptual, and does not accurately represent a travel direction or a state of actual light. For example, in the following drawings, a change in a travel direction or a state of light due to refraction, reflection, diffusion, or the like at an interface between air and a substance may be omitted, or a light flux may be represented by one line.

### First Example Embodiment

First, a light receiving device according to a first example embodiment of the present invention is described with reference to the drawings.

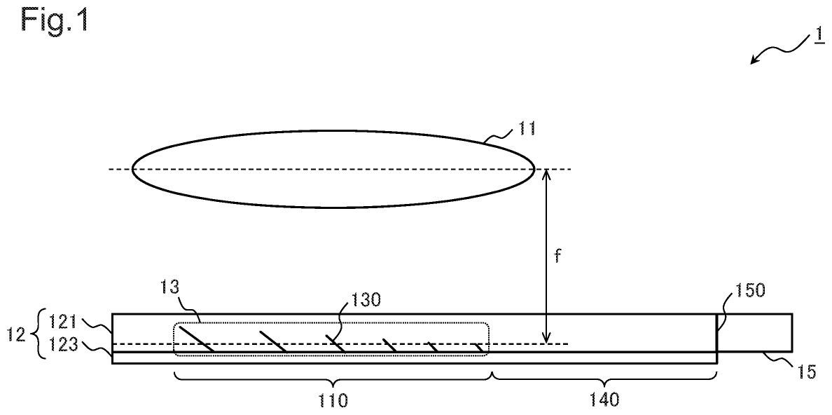

FIG. 1 is a sectional view illustrating a configuration of a light receiving device 1 according to the present example embodiment. The light receiving device 1 includes a lens 11, a directional light guide board 12, and a light receiver 15. The directional light guide board 12 includes a transparent light guide unit 121 and a directional reflection unit 123. A reflection structure 13 in which at least one reflecting mirror 130 is placed is formed in the directional reflection unit 123.

The lens 11 is an optical element that refracts and then converges signal light arriving from outside. The signal light converged by the lens 11 is refracted toward a first surface of the directional light guide board 12. In the present example embodiment, signal light arrives from a sufficiently distant place, and therefore, is regarded as parallel light.

The directional light guide board 12 is disposed at a position which faces a light collection surface of the lens 11, and which signal light refracted by the lens 11 enters. In the present example embodiment, the directional light guide board 12 is disposed at a position including a focus of the lens 11. In other words, the directional light guide board 12 is disposed at a position of a focal distance f from the lens 11. Specifically, the directional light guide board 12 is disposed in such a way that the focus of the lens 11 is located on any of reflection surfaces of the reflection structure 13 formed on an upper surface of the directional reflection unit 123. In other words, at least one reflection surface of the reflection structure 13 is located at the position of the focus of the lens 11.

The directional light guide board 12 includes at least a light collection area 110 into which light collected by the lens 11 enters, a light guide area 140 through which the light entering the light collection area 110 is guided, and an exit end 150 from which the light guided through the light guide area 140 exits. The light collection area 110 indicates a range where light is collected by the lens 11. The light guide area 140 indicates a range from the light collection area 110 up to the light receiver 15. Exit light from the exit end 150 is received by the light receiver 15.

The transparent light guide unit 121 includes an upper surface (also referred to as a first surface) facing the light collection surface of the lens 11, and a lower surface (also referred to as a second surface) facing the first surface. The transparent light guide unit 121 guides, toward the exit end 150, light entering the light collection area 110 from the upper surface. The transparent light guide unit 121 is formed of a material transmitting signal light. For example, the transparent light guide unit 121 can be formed of a material such as glass or plastic. A material of the transparent light guide unit 121 is not limited as long as the material transmits signal light.

The directional reflection unit 123 is disposed on the lower surface of the transparent light guide unit 121. The reflection structure 13 having at least one reflection surface that reflects, toward the exit end 150, light entering from the upper surface in such a way as to satisfy a total reflection condition is formed on an upper surface of the directional reflection unit 123. FIG. 1 illustrates a configuration in which the reflecting mirrors 130 constituting the reflection structure 13 are thinly disposed. Actually, a plurality of the reflecting mirrors 130 are disposed in such a way that signal light collected in the light collection area 110 by the lens 11 is completely reflected. The reflection structure 13 may be configured by an assembly of micro mirrors as in FIG. 1, but may be configured in such a way as to selectively guide signal light of a specific wavelength to the light receiver 15 by wavelength-separating entrance light.

The reflection structure 13 has at least one reflection surface that reflects, toward the exit end 150, light entering from the upper surface in such a way as to satisfy a total reflection condition. In the present example embodiment, the reflection structure 13 is configured by at least one reflecting mirror 130 (also referred to as a reflection unit) having a reflection surface formed in such a way as to reflect, toward the exit end 150, light entering from the upper surface in such a way as to satisfy a total reflection condition. The reflecting mirror 130 is formed of a material reflecting signal light. For example, the reflection structure 13 can be formed of a material such as metal. A material of the reflection structure 13 is not limited as long as the material reflects signal light.

In other words, the directional light guide board 12 is a light guide board being disposed at a focal position of the lens 11, and guiding signal light to the light receiver 15. The directional light guide board 12 has directivity that bends signal light collected by the lens 11 into a light receiving direction of the light receiver 15. An entrance position of signal light into the directional light guide board 12, and a position of the light receiver 15 can be strictly set, and therefore, can be controlled in such a way that signal light entering the directional light guide board 12 is guided toward the light receiver 15.

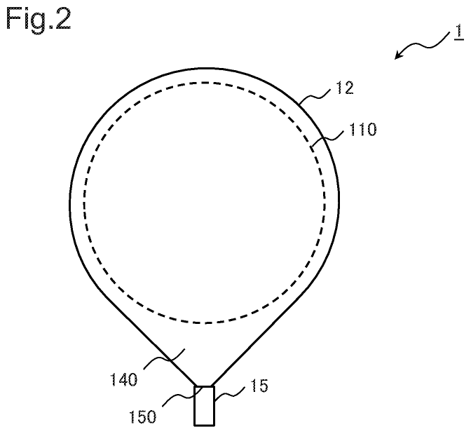

FIG. 2 is a top view of the light receiving device 1. A range of a circle indicated by a broken line in FIG. 2 indicates the light collection area 110 of signal light refracted by the lens 11. In FIG. 2, the reflecting mirrors 130 constituting the reflection structure 13 are omitted.

The directional light guide board 12 is disposed in such a way that the reflecting mirror 130 is located within a range of the light collection area 110 when viewed from the upper surface. The directional light guide board 12 has a drop-shaped form in which the exit end 150 is extended when viewed from the upper surface. In other words, the directional light guide board 12 has a shape in which the light guide area 140 is extended from the light collection area 110 toward the exit end 150. The light receiver 15 is disposed at the exit end 150 located at a vertex of the directional light guide board 12.

In the present example embodiment, signal light refracted by the lens 11 is collected in the reflection structure 13 formed on the upper surface of the directional reflection unit 123. The signal light arriving at the reflection structure 13 is guided to the reflection surface of any of the reflecting mirrors 130 constituting the reflection structure 13. The reflecting mirrors 130 constituting the reflection structure 13 are formed at an angle at which arriving signal light is totally reflected on the upper surface of the transparent light guide unit 121. The signal light reflected on the reflection surface of the reflecting mirror 130 travels to a light receiving unit of the light receiver 15 while being totally reflected on the upper and lower surfaces of the transparent light guide unit 121.

The light receiver 15 is disposed at a position including the vertex of the drop-shaped directional light guide board 12, or a position near the vertex. The light receiver 15 has the light receiving unit that receives signal light guided by the directional light guide board 12. The light receiver 15 converts the received signal light into an electric signal. The light receiver 15 outputs the electric signal to a non-illustrated signal processing device. For example, the light receiver 15 can be achieved by an element such as a photodiode or a phototransistor. The light receiver 15 may be achieved by an element other than a photodiode or a phototransistor as long as the light receiver 15 can convert signal light into an electric signal.

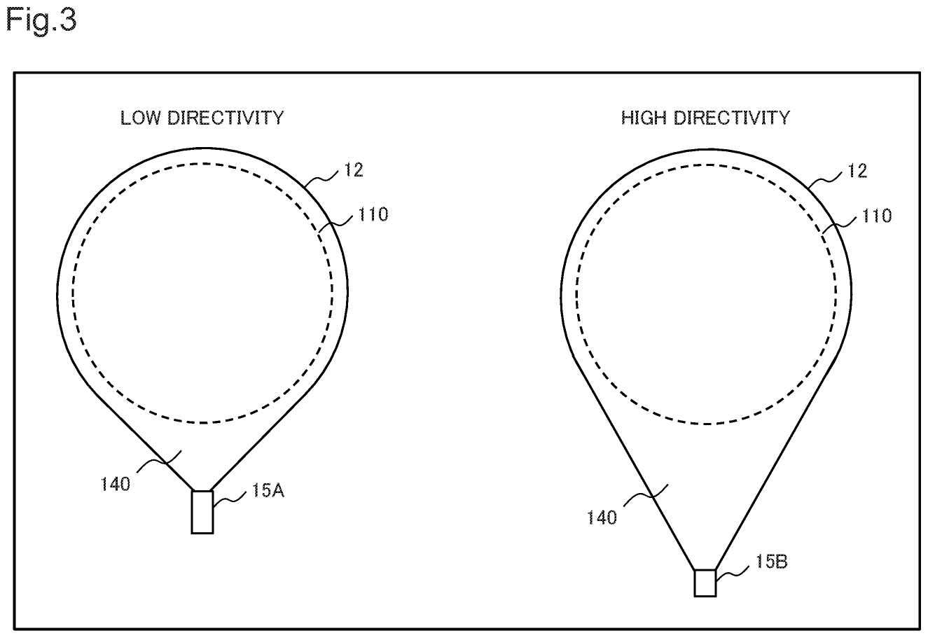

FIG. 3 is a conceptual diagram for describing a directional characteristic of the light receiver 15. A left side is an example using a light receiver 15A having low directivity, and a right side is an example using a light receiver 15B having high directivity. The light receiver 15A having low directivity that can enlarge a light receiving angle is larger in size, and the light receiver 15B having high directivity is smaller in size. The light receiver 15B having high directivity needs a longer stroke of the light guide area 140 than the light receiver 15A having low directivity. Selection of the light receiver 15 may be set according to a size or directivity.

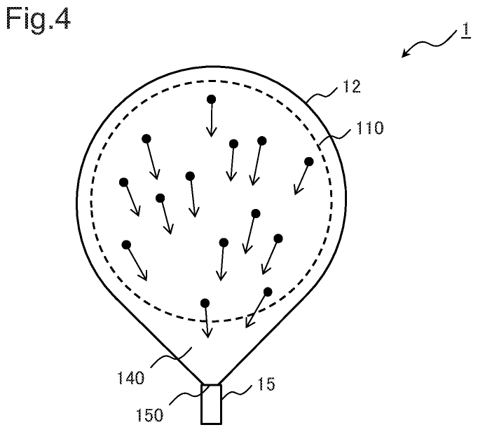

FIG. 4 illustrates a situation where signal light is reflected toward the light receiver 15 by the reflecting mirror 130 disposed at light collection position of signal light indicated by a circle filled with black, in the top view of the directional light guide board 12 illustrated in FIG. 2. Each of the reflecting mirrors 130 constituting the reflection structure 13 is disposed in such a way that the reflection surface thereof is directed to the light receiving unit of the light receiver 15 when viewed from the upper surface.

In the directional light guide board 12, the light guide area 140 between the light collection area 110 and the exit end 150 is set to a shape or length suited to an estimated light receiving angle of the light receiver 15. It is preferable that the light guide area 140 is formed to be elongate when the estimated light receiving angle of the light receiver 15 is small.

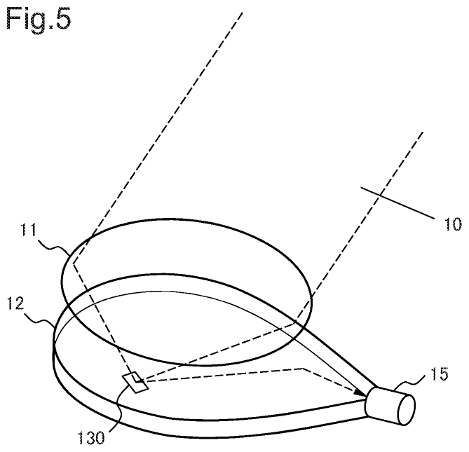

FIG. 5 illustrates a situation where signal light 10 arriving from outside is collected on the reflection surface of the reflecting mirror 130 by the lens 11, totally reflected on both the surfaces of the transparent light guide unit 121 included in the directional light guide board 12 after reflected by the reflection surface of the reflecting mirror 130, and then guided to the light receiving unit of the light receiver 15. Although only one reflecting mirror 130 is illustrated in FIG. 5, the directional light guide board 12 actually includes a plurality of the reflecting mirrors 130.

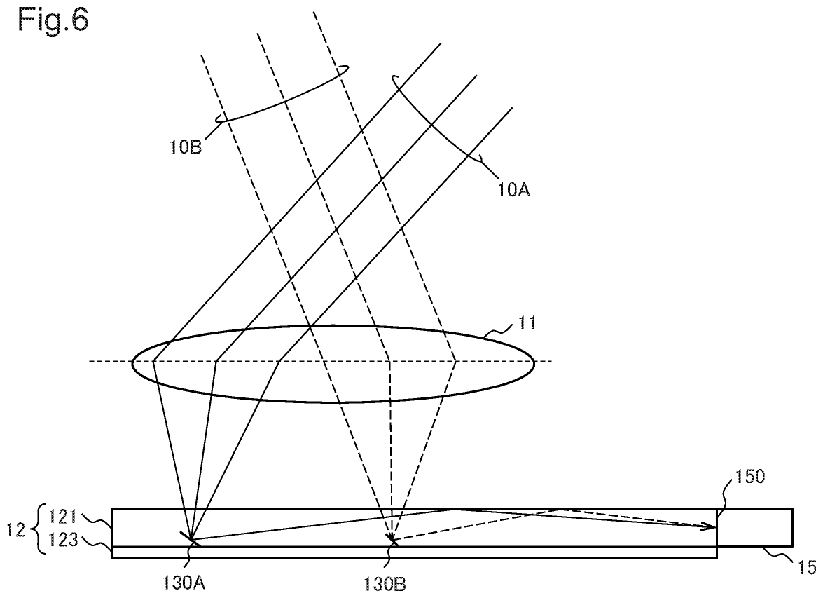

FIG. 6 is a conceptual diagram illustrating a situation where signal light arriving from different directions is guided to the light receiver 15. Signal light 10A is refracted by the lens 11, and then arrives at a reflection surface of a reflecting mirror 130A. The signal light 10A arriving at the reflection surface of the reflecting mirror 130A is totally reflected by the upper and lower surfaces of the transparent light guide unit 121, and then guided to the light receiver 15. Similarly, signal light 10B is refracted by the lens 11, and then arrives at a reflection surface of a reflecting mirror 130B. The signal light 10B arriving at the reflection surface of the reflecting mirror 130B is totally reflected by the upper and lower surfaces of the transparent light guide unit 121, and then guided to the light receiver 15.

In other words, the signal light 10 entering the lens 11 is collected in a part where a ray passing through a focus of the lens 11 in an opening direction is perpendicularly applied to the directional reflection unit 123, regardless of an arrival direction. The signal light 10 is reflected toward the light receiver 15 in the reflection surface of the reflecting mirror 130 formed in the directional reflection unit 123. The signal light 10 reflected by the reflection surface of the reflecting mirror 130 is totally reflected by the upper and lower surfaces of the transparent light guide unit 121, and guided to the light receiver 15. Although not illustrated in FIG. 6, the reflection structure 13 is formed on the whole upper surface of the directional reflection unit 123 at a position of the light collection area 110 of the lens 11. On the upper surface of the directional reflection unit 123, a part between the reflection structure 13 and the light receiver 15 is an area (a light guide area 140) for light guiding. A shape of the light guide area 140 is determined according to an estimated light receiving angle of the light receiver 15.

As described above, the light receiving device according to the present example embodiment is provided with a lens that collects signal light, collects signal light arriving from multiple directions on any of reflection surfaces constituting a reflection structure, and guides reflected light of the signal light to a photodiode. Since a position relation between a shape of a light flux coming to a light collection point and the photodiode is uniquely determined, the light receiving device can adapt to signal light arriving at the lens from any direction by correctly setting a shape of the reflection structure. Thus, even when signal light arrives from any direction, the light receiving device according to the present example embodiment can collect the signal light in a photodiode being capable of high-speed communication and having a small light receiving area as long as the signal light can be collected by the lens. In other words, the light receiving device according to the present example embodiment can efficiently receive signal light even in a situation where an arrival direction of the signal light used in an optical space communication is not uniquely determined.

### Modification Examples

Herein, modification examples of the light receiving device 1 according to the first example embodiment are described with reference to the drawings.

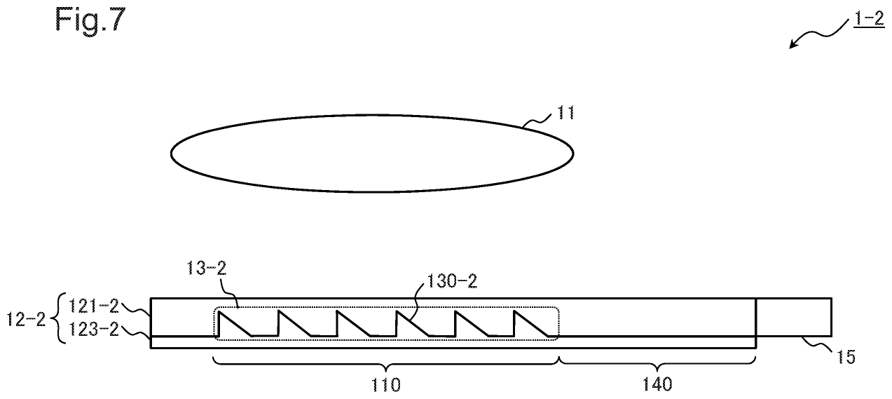

FIG. 7 is a sectional view illustrating a configuration of a light receiving device 1-2. A directional light guide board 12-2 of the light receiving device 1-2 includes a transparent light guide unit 121-2 and a directional reflection unit 123-2. A reflection structure 13-2 formed in such a way that at least one reflection unit 130-2 protrudes is formed on an upper surface of a light collection area 110 of the directional reflection unit 123-2. For example, the reflection unit 130-2 is formed in such a way that a reflection surface thereof is disposed similarly to the reflection surface of the reflecting mirror 130 in the light receiving device 1 according to the first example embodiment.

The reflection structure 13-2 of the light receiving device 1-2 can be formed by processing an upper surface of the directional reflection unit 123-2. It is preferable that a material having high reflectivity such as metal is vapor-deposited on a surface of the reflection structure 13-2 in such a way as to easily reflect light. For example, the reflection structure 13-2 can be formed by processing the upper surface of the directional reflection unit 123-2 by etching or the like, and vapor-depositing, on the upper surface, a material having high reflectivity such as metal. For example, the reflection structure 13-2 can be formed by vapor-depositing a material having high reflectivity such as metal on the upper surface of the directional reflection unit 123-2 that is formed by injection molding or a three-dimensional printer. The configuration in FIG. 7 is one example, and does not limit the reflection unit 130-2 in shape, height, number, and the like.

According to the configuration in FIG. 7, a reflection structure can be formed by processing an upper surface of a directional reflection unit, and therefore, an angle of a reflection surface can be more strictly formed than the configuration in FIG. 1. Thus, a reflection surface having high accuracy in a reflection direction can be provided.

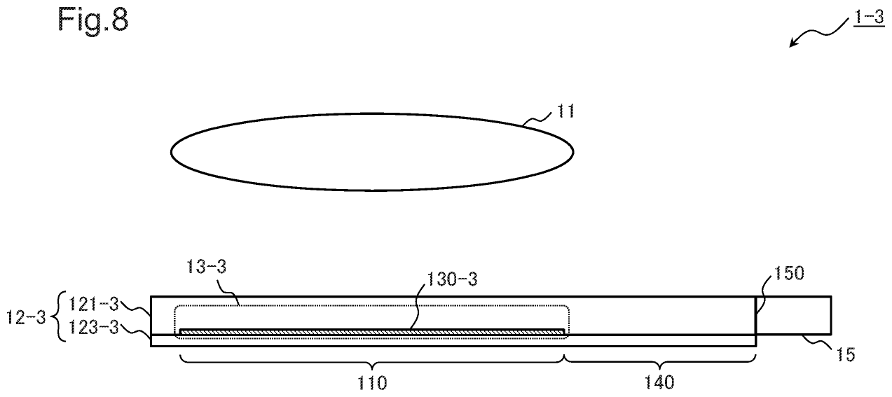

FIG. 8 is a sectional view illustrating a configuration of a light receiving device 1-3. A directional light guide board 12-3 of the light receiving device 1-3 includes a transparent light guide unit 121-3 and a directional reflection unit 123-3. A diffraction grating array 130-3 is disposed on a surface of the directional reflection unit 123-3 on the transparent light guide unit 121-3 side.

The diffraction grating array 130-3 is configured by a reflecting type diffraction grating having a structure in which a plurality of gratings having a micrometer-order height are arrayed. The diffraction grating array 130-3 diffracts the entrance light in such a way that light entering the transparent light guide unit 121-3 from an upper surface of the directional light guide board 12-3 travels toward an exit end 150 and in such a way as to satisfy a total reflection condition. For example, the diffraction grating array 130-3 can be achieved by a blazed diffraction grating or a holographic diffraction grating. It is preferable that the diffraction grating array 130-3 is configured by changing grating spacing in such a way as to satisfy a total reflection condition.

According to the configuration in FIG. 8, the whole height of the reflection structure can be configured to be low, and therefore, a directional light guide board can be thinned as compared to the configurations in FIGS. 1 and 7.

(Related Technique)

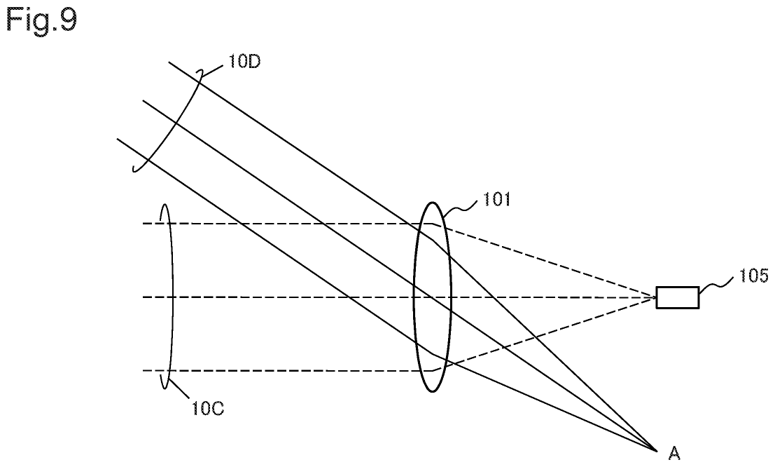

Herein, in order to describe an advantageous effect of the light receiving device 1 according to the present example embodiment, a light receiving method of a related technique is described with reference to the drawings. FIG. 9 is a conceptual view for describing the light receiving method of the related technique.

In the example of FIG. 9, signal light 10C arriving from front along an optical axis of a lens 101 is collected by the lens 101 and then received by a photodiode 105. In the example of FIG. 9, signal light 10D arriving diagonally relative to the optical axis of the lens 101 is collected not in a light receiving unit of the photodiode 105 but at a point A. In order to receive, by the photodiode 105, signal light 10D collected at the point A, a large photodiode 105 having a light receiving unit being much the same as an aperture of the lens 101 is needed. In order to perform high-speed communication required for an optical space communication, capacitance of the photodiode 105 is preferably small. Thus, the method of the related technique that needs a large photodiode 105 is not suitable for an optical space communication.

In contrast, in a light receiving method according to the present example embodiment, light arriving from various directions is collected by a lens, and the collected light can be efficiently guided to a light receiving unit of a photodiode by a directional light guide board. In other words, in the light receiving method according to the present example embodiment, signal light can be collected in a photodiode having a small light receiving area as long as the signal light can be collected by the lens. Therefore, signal light can be efficiently received even in a situation where an arrival direction of the signal light used in an optical space communication is not uniquely determined.

### Second Example Embodiment

Next, a light receiving device according to a second example embodiment of the present invention is described with reference to the drawings. The light receiving device according to the present example embodiment is different from the light receiving device according to the first example embodiment in that a plane mirror is disposed in a light guide area of a directional light guide board.

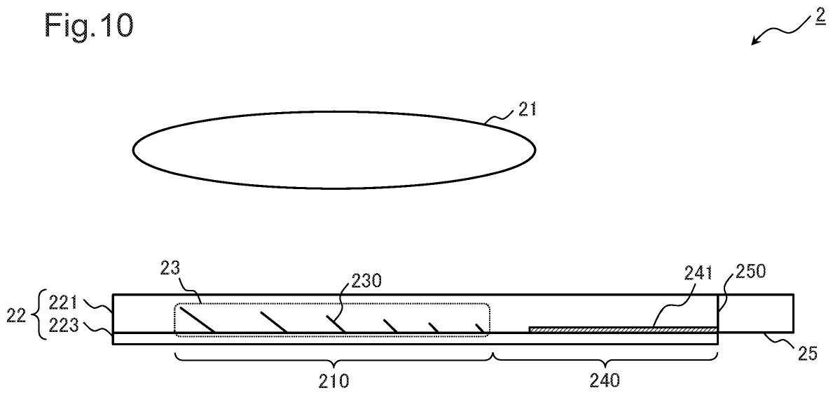

FIG. 10 is a sectional view illustrating a configuration of a light receiving device 2 according to the present example embodiment. The light receiving device 2 includes a lens 21, a directional light guide board 22, and a light receiver 25. The directional light guide board 22 includes a transparent light guide unit 221 and a directional reflection unit 223. A reflection structure 23 in which at least one reflecting mirror 230 is placed is formed in the directional reflection unit 223. A plane mirror 241 is disposed in a light guide area 240. In other words, the directional light guide board 22 has the plane mirror 241 disposed in the light guide area 240 between the transparent light guide unit 221 and the directional reflection unit 223 in such a way that a reflection surface is directed to an upper surface. In the directional light guide board 22, a light collection area 210 indicates a range where light is collected by the lens 21, and a light guide area 240 indicates a range from the light collection area 210 up to an exit end 250. A component other than the plane mirror 241 among components of the light receiving device 2 is similar to a corresponding component according to the first example embodiment, and therefore, detailed description is omitted.

The plane mirror 241 is disposed within a range of the light guide area 240 in an upper surface of the directional reflection unit 223. The plane mirror 241 may cover all or a part of the upper surface of the directional reflection unit 223 within the range of the light guide area 240. The reflection surface of the plane mirror 241 is disposed in such a way as to contact a lower surface of the transparent light guide unit 221. The plane mirror 241 may be disposed on the lower surface of the transparent light guide unit 221, and configured in such a way as to contact the upper surface of the directional reflection unit 223. In other words, the plane mirror 241 is disposed in such a way that the reflection surface contacts the lower surface of the transparent light guide unit 221 within the range of the light guide area 240 at a position intervening between the lower surface of the transparent light guide unit 221 and the upper surface of the directional reflection unit 223.

As in FIG. 1, in a case of the light receiving device 1 according to the first example embodiment, in the light guide area 140, light traveling inside the transparent light guide unit 121 is totally reflected between the upper and lower surfaces of the transparent light guide unit 121, and then arrives at a light receiving unit of the light receiver 15. When the upper surface of the directional reflection unit 123 is not mirror-finished, there is a possibility that loss of light occurs between the lower surface of the transparent light guide unit 121 and the upper surface of the directional reflection unit 123 in a case where a stroke of the light guide area 140 becomes long.

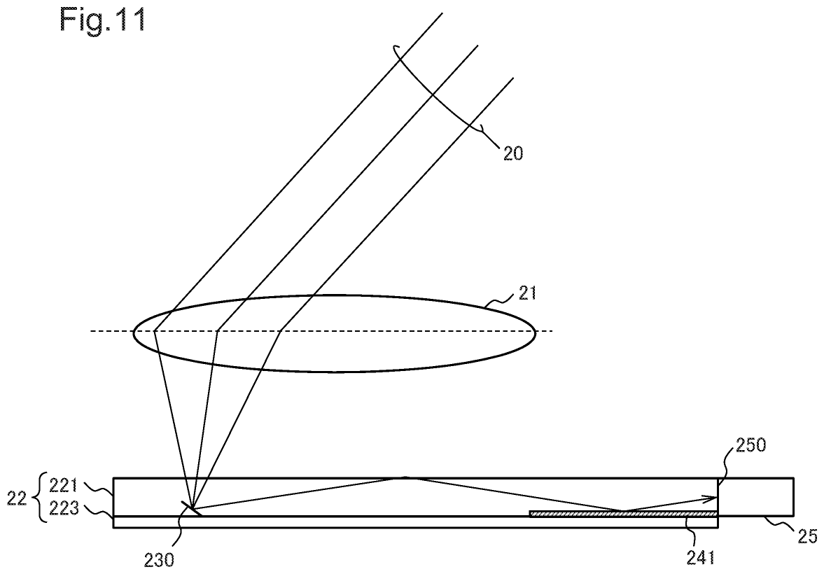

On the other hand, in the light receiving device 2 according to the present example embodiment, signal light 20 arriving at the lens 21 is refracted by the lens 11, and then arrives at a reflection surface of the reflecting mirror 230 formed in the directional reflection unit 223, as in FIG. 11. The signal light 20 arriving at the reflection surface of the reflecting mirror 230 is reflected by the reflection surface, and travels toward an upper surface of the transparent light guide unit 221 in such a way as to satisfy a total reflection condition. Light arriving at the light guide area 240 is reflected by the reflection surface of the plane mirror 241, on the lower surface of the transparent light guide unit 221. In other words, in the light receiving device 2, a possibility that loss of light occurs can be reduced by disposing the plane mirror 241 between the lower surface of the transparent light guide unit 221 and the upper surface of the directional reflection unit 223.

As above, the light receiving device according to the present example embodiment can reduce loss of light in a light guide area by disposing a reflecting mirror in the light guide area of the directional light guide board.

### Third Example Embodiment

Next, a light receiving device according to a third example embodiment of the present invention is described with reference to the drawings. The light receiving device according to the present example embodiment is different from the light receiving device according to the first example embodiment in that a color filter that selectively transmits light of a specific wavelength is disposed in front of a light receiving unit of a light receiver. For example, in the present example embodiment, a color filter that selectively transmits light of a wavelength is disposed in a light receiving unit of each of a plurality of photodiodes.

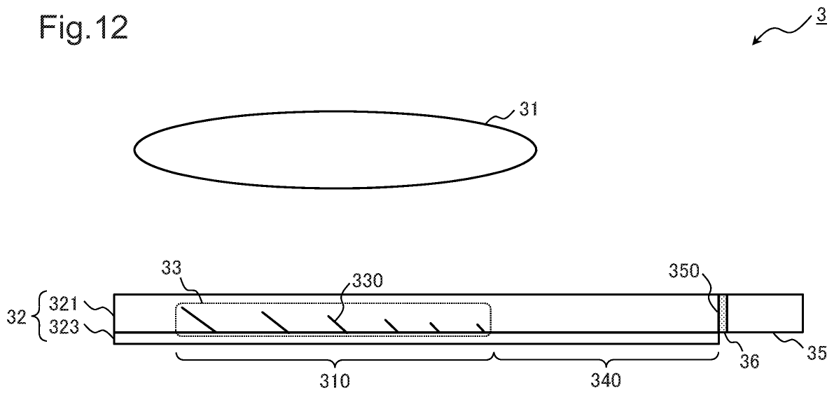

FIG. 12 is a sectional view illustrating a configuration of a light receiving device 3 according to the present example embodiment. The light receiving device 3 includes a lens 31, a directional light guide board 32, a light receiver 35, and a color filter 36. In the directional light guide board 32, a light collection area 310 indicates a range where light is collected by the lens 31, and a light guide area 340 indicates a range from the light collection area 310 up to an exit end 350. The directional light guide board 32 includes a transparent light guide unit 321 and a directional reflection unit 323. A reflection structure 33 in which at least one reflecting mirror 330 is placed is formed in the directional reflection unit 323. A component other than the light receiver 35 and the color filter 36 among components of the light receiving device 3 is similar to a corresponding component according to the first example embodiment, and therefore, detailed description is omitted.

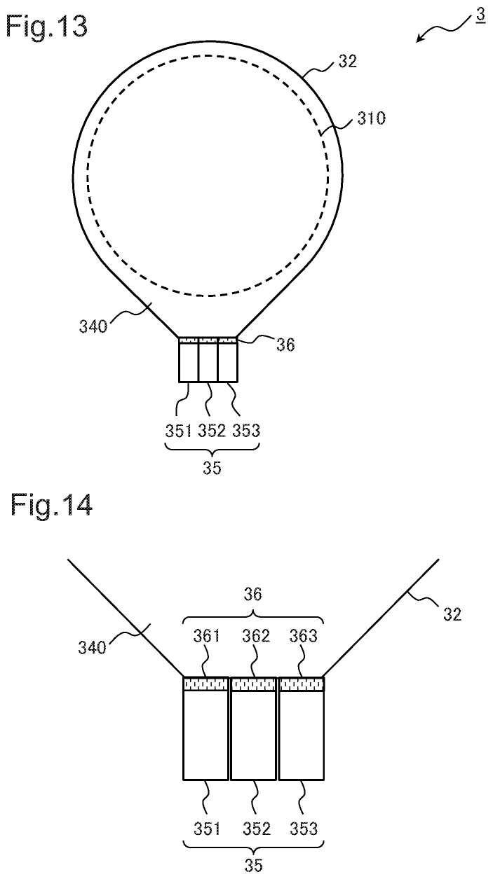

FIG. 13 is a top view illustrating the configuration of the light receiving device 3. The light receiver 35 is constituted of a first light receiver 351, a second light receiver 352, and a third light receiver 353. For the first light receiver 351, the second light receiver 352, and the third light receiver 353, light receivers of the same specification may be used, or light receivers of different specifications may be used.

FIG. 14 is a conceptual diagram illustrating a configuration of the color filter 36 of the light receiving device 3. The color filter 36 is constituted of a first filter 361, a second filter 362, and a third filter 363. The first filter 361, the second filter 362, and the third filter 363 selectively transmit light of wavelengths different from one another. For example, the first filter 361 selectively transmits light of a wavelength λ1, the second filter 362 selectively transmits light of a wavelength λ2, and the third filter 363 selectively transmits light of a wavelength λ3.

The first filter 361 selectively transmits light of the wavelength λ1. Thus, the first light receiver 351 receives the light of the wavelength λ1 passing through the first filter 361. The second filter 362 selectively transmits light of the wavelength λ2. Thus, the second light receiver 352 receives the light of the wavelength λ2 passing through the second filter 362. The third filter 363 selectively transmits light of the wavelength λ3. Thus, the third light receiver 353 receives the light of the wavelength λ3 passing through the third filter 363.

In other words, each of the first light receiver 351, the second light receiver 352, and the third light receiver 353 constituting the light receiver 35 can selectively receive light in which a light component in an unnecessary wavelength region is removed by the color filter 36. A single color filter may be configured to be disposed in front of a light receiving unit of a single light receiver.

As above, in the light receiving device according to the present example embodiment, light in which light in an unnecessary wavelength region is removed by a color filter is received by a photodiode. Thus, the light receiving device according to the present example embodiment can receive signal light in which background light or a disturbance component is removed, even when the background light or the disturbance component is included. The light receiving device according to the present example embodiment can selectively receive signal light in a wavelength region to which a photodiode has high sensitivity, and therefore, sufficient light receiving capability can be acquired even when performance of the photodiode is slightly low.

### Fourth Example Embodiment

Next, a light receiving device according to a fourth example embodiment of the present invention is described with reference to the drawings. The light receiving device according to the present example embodiment is different from the light receiving device according to the first example embodiment in that a color separation means for selectively color-separating light exiting from an exit end toward a plurality of light receivers is disposed.

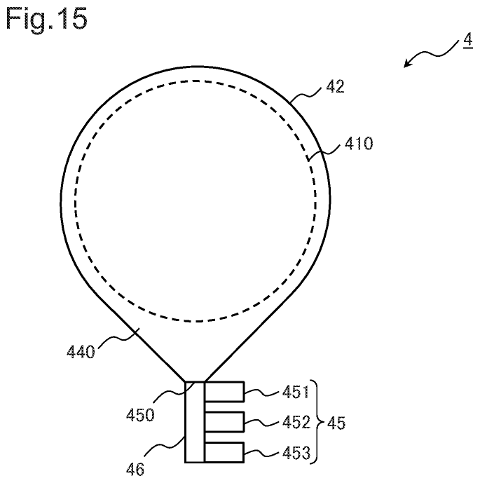

FIG. 15 is a top view illustrating a configuration example of a light receiving device 4 according to the present example embodiment. The light receiving device 4 includes a lens (not illustrated), a directional light guide board 42, a light receiver 45, and a color separation unit 46. In the directional light guide board 42, a light collection area 410 indicates a range where light is collected by the lens, and a light guide area 440 indicates a range from the light collection area 410 up to an exit end 450. Although not illustrated, the directional light guide board 42 includes a transparent light guide unit and a directional reflection unit. Although not illustrated, a reflection structure in which at least one reflecting mirror is placed is formed in the directional reflection unit. A component other than the light receiver 45 and the color separation unit 46 among components of the light receiving device 4 is similar to a corresponding component according to the first example embodiment, and therefore, detailed description is omitted.

The light receiver 45 is constituted of a first light receiver 451, a second light receiver 452, and a third light receiver 453. The first light receiver 451, the second light receiver 452, and the third light receiver 453 may be configured in such a way as to detect light of the same wavelength region, or may be configured in such a way as to detect light of different wavelength regions. For example, the first light receiver 451 may be configured in such a way as to detect light in a wavelength region including a wavelength λ1, the second light receiver 452 may be configured in such a way as to detect light in a wavelength region including a wavelength λ2, and the third light receiver 453 may be configured in such a way as to detect light in a wavelength region including a wavelength λ3. At least two of the first light receiver 451, the second light receiver 452, and the third light receiver 453 may be configured in such a way as to detect light of the same wavelength region.

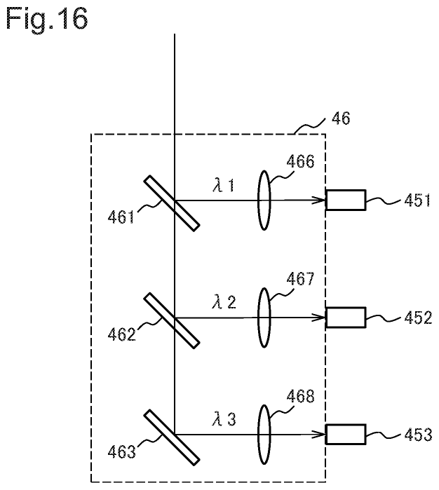

FIG. 16 is a conceptual diagram illustrating a configuration of the color separation unit 46. The color separation unit 46 is constituted of a first mirror 461, a second mirror 462, a third mirror 463, a first lens 466, a second lens 467, and a third lens 468.

The first mirror 461 and the second mirror 462 selectively reflect light of wavelengths different from each other. For example, the first mirror 461 selectively reflects light of the wavelength λ1, and the second mirror 462 selectively reflects light of the wavelength λ2. The third mirror 463 reflects light of all wavelengths. The third mirror 463 may be configured in such a way as to selectively reflect light of the wavelength λ3. The first lens 466, the second lens 467, and the third lens 468 collect light reflected by the first mirror 461, the second mirror 462, and the third mirror 463 in light receiving units of the first light receiver 451, the second light receiver 452, and the third light receiver 453.

The first mirror 461 is a reflection dichroic mirror that selectively reflects light of the wavelength λ1. The first mirror 461 transmits light other than light of the wavelength λ1. Thus, the first light receiver 451 receives light of the wavelength λ1 reflected by the first mirror 461. The second mirror 462 is a reflection dichroic mirror that selectively reflects light of the wavelength λ2. The second mirror 462 transmits light other than light of the wavelength λ2. Thus, the second light receiver 452 receives light of the wavelength λ2 reflected by the second mirror 462. The third mirror 463 is a reflection dichroic mirror that selectively reflects light of the wavelength λ3, or a normal mirror. The third mirror 463 transmits light other than light of the wavelength λ3, or reflects light of all wavelength regions. Thus, the third light receiver 453 receives light of the wavelength λ3 reflected by the third mirror 463, or light in which light of the wavelength λ1 and the wavelength λ2 is removed.

In other words, the color separation unit 46 includes at least one dichroic mirror that selectively reflects light in at least one wavelength region out of light exiting from the exit end 450. Each of the plurality of light receivers is disposed in such a way as to receive at least any of light reflected by the dichroic mirror. Each of the plurality of light receivers constituting the light receiver 45 can selectively receive light in a specific wavelength region separated by the color separation unit 46.

Next, a light receiving device 4-2 having a function similar to that of the light receiving device 4 is described with reference to the drawings.

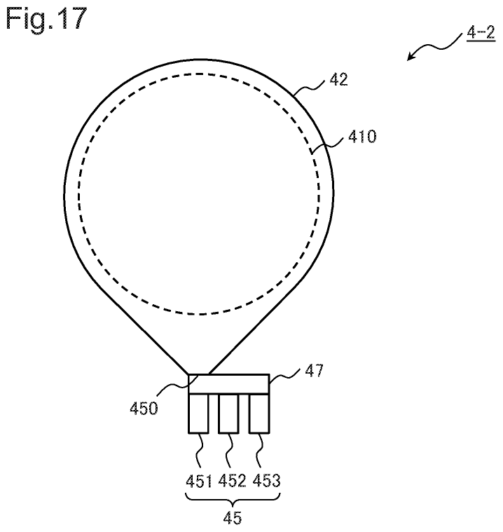

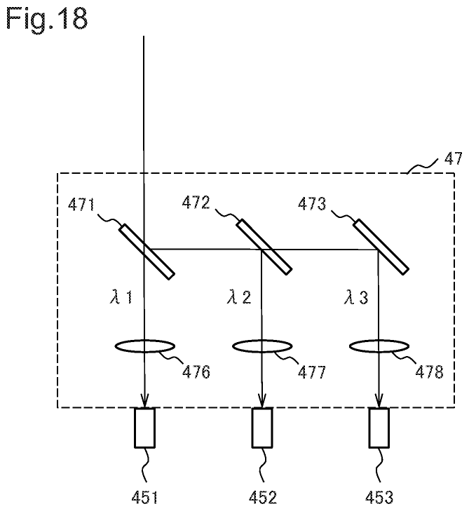

FIG. 17 is a top view illustrating a configuration example of the light receiving device 4-2 according to the present example embodiment. The light receiving device 4-2 is similar to the light receiving device 4 except for having a color separation unit 47 being different from the color separation unit 46 of the light receiving device 4. FIG. 18 is a conceptual diagram illustrating a configuration of the color separation unit 47. A component of the light receiving device 4-2 other than the color separation unit 47 is similar to that of the light receiving device 4 (FIGS. 15 and 16), and repeated description may be omitted below.

The color separation unit 47 is constituted of a first mirror 471, a second mirror 472, a third mirror 473, a first lens 476, a second lens 477, and a third lens 478. The first mirror 471 selectively transmits light of a specific wavelength, and reflects light of other wavelengths. The second mirror 472 selectively reflects light of a specific wavelength, and transmits light of other wavelengths. The third mirror 473 reflects light of all wavelengths. The light of all wavelengths means all of light in a wavelength region including signal light, and may not include a wavelength that is not involved in reception of the signal light. For example, the first mirror 471 selectively transmits light of the wavelength λ1, the second mirror 472 selectively reflects light of the wavelength λ2, and the third mirror 473 reflects light of all wavelengths. The first lens 476 collects light transmitted by the first mirror 471 in the light receiving unit of the first light receiver 451. The second lens 477 and the third lens 478 each collects, in the light receiving unit of the second light receiver 452 or the third light receiver 453, light reflected by the second mirror 472 and the third mirror 473.

The first mirror 471 is a transmission dichroic mirror that selectively transmits light of the wavelength λ1. The first mirror 471 reflects light other than light of the wavelength λ1. Thus, the first light receiver 451 receives light of the wavelength λ1 transmitted through the first mirror 471. The second mirror 472 is a reflection dichroic mirror that selectively reflects light of the wavelength λ2. The second mirror 472 transmits light other than light of the wavelength λ2. Thus, the second light receiver 452 receives light of the wavelength λ2 reflected by the second mirror 472. The third mirror 473 is a mirror that reflects light of all wavelengths. The third mirror 473 transmits or totally reflects light other than light of the wavelength λ3. Thus, the third light receiver 453 receives light of the wavelength λ3 reflected by the third mirror 463, or light in which light of the wavelength λ1 and the wavelength λ2 is removed.

In other words, the color separation unit 47 includes at least one dichroic mirror that selectively transmits light in at least one wavelength region out of light exiting from the exit end 450. Each of the plurality of light receivers constituting the light receiver 45 is disposed in such a way as to receive at least any of light transmitted by the dichroic mirror, and can selectively receive light of a specific wavelength region separated by the color separation unit 47.

As above, in the light receiving device according to the present example embodiment, light selected by a color separation unit is received by a light receiver. Thus, the light receiving device according to the present example embodiment can receive signal light in which background light or a disturbance component is not included, even when the background light or the disturbance component is included. The light receiving device according to the present example embodiment can selectively receive signal light in a wavelength region to which the light receiver has high sensitivity, and therefore, sufficient light receiving capability can be acquired even when performance of the light receiver is slightly low.

### Fifth Example Embodiment

Next, a light receiving device according to a fifth example embodiment of the present invention is described with reference to the drawings. The light receiving device according to the present example embodiment is different from the light receiving device according to the first example embodiment in that light is received by a plurality of light receivers.

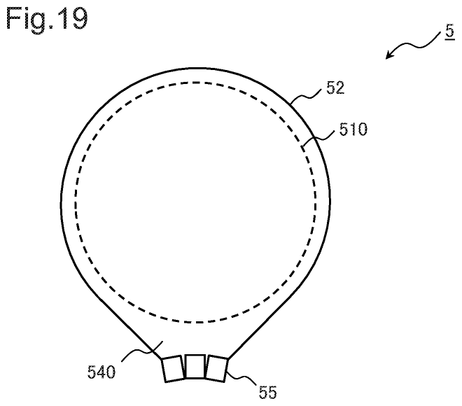

FIG. 19 is a top view illustrating a configuration example of a light receiving device 5 according to the present example embodiment. The light receiving device 5 includes a lens (not illustrated), a directional light guide board 52, and a light receiver 55. In the directional light guide board 52, a light collection area 510 indicates a range where light is collected by the lens, and a light guide area 540 indicates a range from the light collection area 510 up to the light receiver 55. Although not illustrated, the directional light guide board 52 includes a transparent light guide unit and a directional reflection unit. Although not illustrated, a reflection structure in which at least one reflecting mirror is placed is formed in the directional reflection unit. A component other than the light receiver 55 among components of the light receiving device 5 is similar to a corresponding component according to the first example embodiment, and therefore, detailed description is omitted.

As described by use of FIG. 3, when a light receiver having high light receiving directivity is used, a stroke of the light guide area 540 of the directional light guide board 52 needs to be elongated. When the stroke of the light guide area 540 is elongated, the whole device is enlarged.

The light receiver 55 including a plurality of light receivers having high light receiving directivity is used for the light receiving device 5 according to the present example embodiment. The plurality of light receivers included in the light receiver 55 are disposed in such a way that light receiving directions thereof are different from one another according to a travel direction of light guided through the light guide area 540.

The individual light receiver included in the light receiver 55 can be configured by a small-sized light receiver. While the plurality of light receivers having high light receiving directivity are used, the stroke of the light guide area 540 can be shortened. In other words, the light receiving device 5 according to the present example embodiment can enlarge a light receiving angle by covering with the plurality of light receivers having high directivity, and can be small-sized while maintaining performance because high-speed performance is maintained.

As above, the light receiving device according to the present example embodiment can maintain high light receiving directivity by using a plurality of light receivers having high light receiving directivity, even when a stroke of a light guide area is short. A light receiver having high directivity is capable of being small-sized. Thus, according to the present example embodiment, the light receiving device can be small-sized. The light receiving device according to the present example embodiment can also be applied to color multiplexing for receiving signal light in a plurality of wavelength regions by changing wavelength ranges in which a plurality of light receivers receive light.

### Sixth Example Embodiment

Next, a light receiving device according to a sixth example embodiment of the present invention is described with reference to the drawings. The light receiving device according to the present example embodiment is different from the light receiving device according to the first example embodiment in that at least a part of a directional light guide board can be folded.

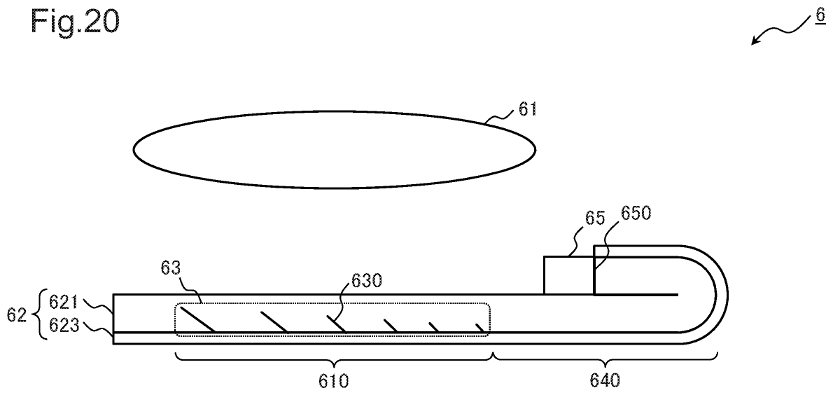

FIG. 20 is a sectional view illustrating a configuration of a light receiving device 6 according to the present example embodiment. The light receiving device 6 includes a lens 61, a directional light guide board 62, and a light receiver 65. The directional light guide board 62 includes a transparent light guide unit 621 and a directional reflection unit 623. A reflection structure 63 in which at least one reflecting mirror 630 is placed is formed in the directional reflection unit 623. At least a part of a light guide area 640 of the directional light guide board 62 has a foldable flexible structure. The light receiver 65 is mounted on an upper surface of the transparent light guide unit 621 in such a way that a light receiving unit is located at an exit end 650 of the light guide area 640 of the directional light guide board 62 that is folded back. In the directional light guide board 62, a light collection area 610 indicates a range where light is collected by the lens 61, and the light guide area 640 indicates a range from the light collection area 610 up to the exit end 650. A part other than at least a part of the light guide area 640 of the directional light guide board 62 among components of the light receiving device 6 is similar to a corresponding component according to the first example embodiment, and therefore, detailed description is omitted.

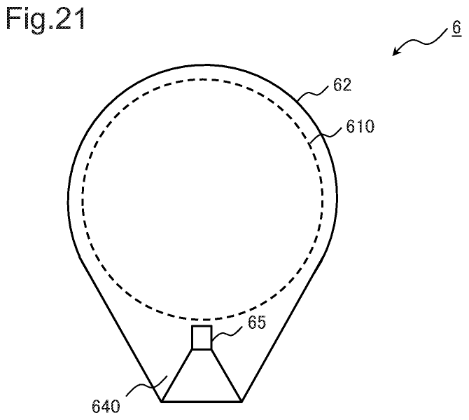

FIG. 21 is a top view illustrating a configuration example of the light receiving device 6 according to the present example embodiment. The light receiving device 6 has a structure in which at least a part of the light guide area 640 of the directional light guide board 62 is folded back, and therefore, can elongate a stroke from the light collection area 610 up to the light receiving unit of the light receiver 65. A highest portion of a part in which at least a part of the light guide area 640 of the directional light guide board 62 is folded back can be set to be lower than a highest portion of the lens 61. Thus, according to the present example embodiment, a light receiving angle is small, and the whole device can be small-sized even when the light receiver 65 having high light receiving directivity is used.

FIGS. 20 and 21 illustrate a configuration in which the light receiver 65 is mounted on an upper surface (also referred to as a first surface) of the directional light guide board 62 by folding at least a part of the light guide area 640. However, a folding direction and a folding pattern of the light guide area 640 of the directional light guide board 62 are not limited to a direction illustrated in FIG. 20. For example, the light guide area 640 may be folded toward a direction perpendicular to a surface of FIG. 20. The light guide area 640 of the directional light guide board 62 may be folded in such a way as to be stacked twofold or more, or may be folded in such a way as to be twisted.

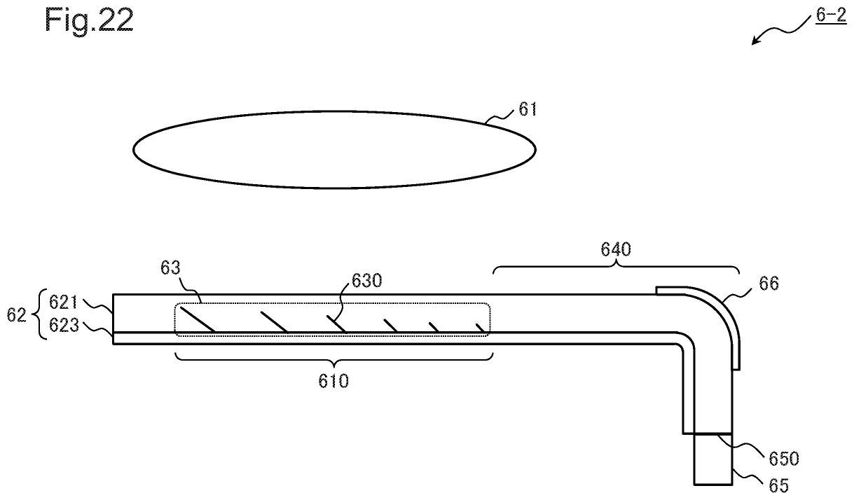

FIG. 22 is a sectional view illustrating a configuration of a light receiving device 6-2 according to a modification example of the present example embodiment. The light receiving device 6-2 according to the present modification example is different from the light receiving device 6 in that a foldable reflecting mirror 66 is disposed in at least a part of a foldable portion of the light guide area 640. The reflecting mirror 66 is disposed in such a way that a reflection surface thereof faces the directional reflection unit 623.

Normally, light arriving at the light guide area 640 satisfies a condition of being totally reflected on both surfaces of the transparent light guide unit 621. However, when the light guide area 640 is folded to a side opposite to the lens 61, the upper surface of the transparent light guide unit 621 in the folded part may not satisfy a total reflection condition. According to the present modification example, the total reflection condition can be satisfied in the whole light guide area 640 by disposing the reflecting mirror 66 on an upper surface side of a foldable area of the transparent light guide unit 621.

As above, in the light receiving device according to the present example embodiment, at least a part of a light guide area of a directional light guide board can be folded, and therefore, the whole device can be small-sized. According to the present example embodiment, a shape of the directional light guide board can be changed according to a shape of a housing that houses the light receiving device, and therefore, a degree of freedom in a shape of the housing increases.

### Application Examples

Next, application examples of the light receiving device according to each example embodiment of the present invention are described with reference to the drawings. The light receiving device according to each example embodiment is suitable for an optical space communication when a position relation between a transmission side and a reception side is not determined. In the following application examples, an optical space communication between fixed equipment and a mobile unit, an optical space communication between mobile units, and the like are described by citing one example. Although the light receiving device according to each example embodiment is not illustrated in the drawings, it is assumed below that each component is equipped with the light receiving device according to each example embodiment. It is assumed below that each component is equipped with a light sending device that transmits signal light received by the light receiving device according to each example embodiment.

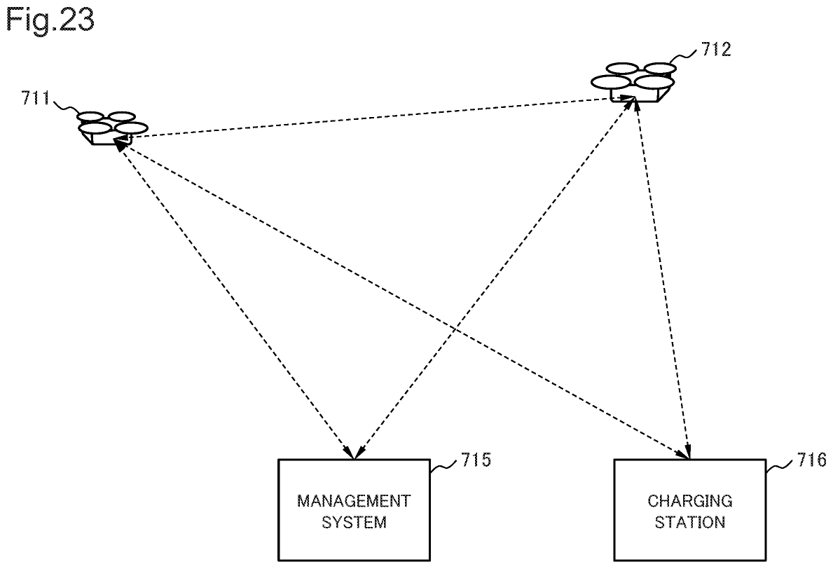

FIG. 23 is an example in which a drone is equipped with the light receiving device according to each example embodiment. FIG. 23 illustrates two drones (drones 711 and 712). FIG. 23 illustrates a management system 715 that controls movement of the drone, and a charging station 716 for charging the drone. It is assumed that each of the management system 715 and the charging station 716 is also equipped with the light receiving device according to each example embodiment. The drones 711 and 712 move within a range in which the drones 711 and 712 can perform an optical space communication with the management system 715 and the charging station 716. The number of drones is not limited to two, and may be any number. A target with which the drone performs an optical space communication is not limited to the management system 715 and the charging station 716.

For example, when transmitting some information to the drone 712, the drone 711 sends communication light toward the drone 712. Even though the drone 712 does not accurately recognize a direction in which the signal light sent from the drone 711 arrives, the drone 712 can receive the signal light from the drone 712 as long as the signal light arrives from a direction in which light is receivable by the light receiving device. When receiving the information from the drone 711, the drone 712 performs an operation suited to the received information.

For example, when controlling movement of the drone 711, the management system 715 sends, toward the drone 711, signal light for controlling the drone 711. Even though the drone 711 does not accurately recognize a direction in which the signal light sent from the management system 715 arrives, the drone 711 can receive the signal light from the management system 715 as long as the signal light arrives from a direction in which light is receivable by the light receiving device. The drone 711 receiving the signal light from the management system 715 moves under the control of the management system 715.

For example, when needing to be charged at the charging station 716, the drone 711 sends, toward the charging station 716, signal light requesting for utilization of the charging station 716. Even though the charging station 716 does not accurately recognize a direction in which the signal light sent from the drone 711 arrives, the charging station 716 can receive the signal light from the drone 711 as long as the signal light arrives from a direction in which light is receivable by the light receiving device. The charging station 716 receiving the signal light from the drone 711 sends, toward the drone 711, signal light including permission for use of the charging station 716, according to use status of the charging station 716. When receiving the signal light from the charging station 716, the drone 711 operates according to the permission for use of the charging station 716.

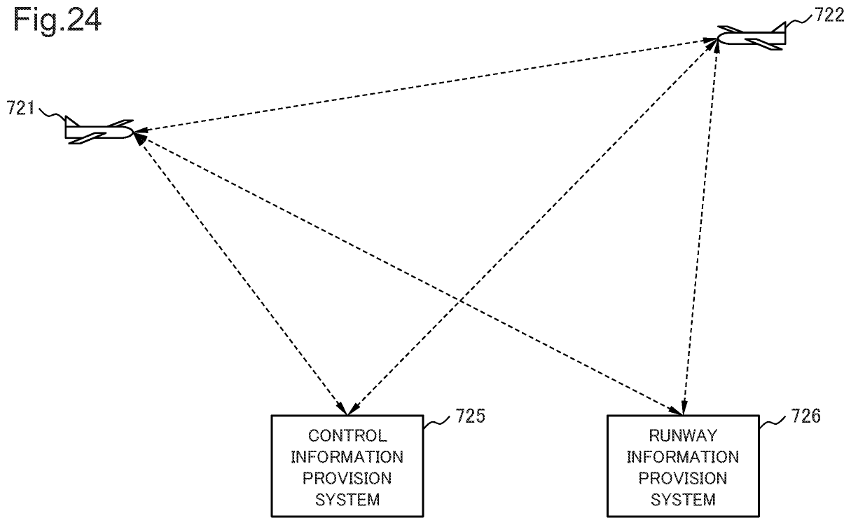

FIG. 24 is an example in which a plane is equipped with the light receiving device according to each example embodiment. FIG. 24 illustrates two planes (planes 721 and 722). FIG. 24 illustrates a control information provision system 725 that provides information relating to operation status of the plane or use status of a runway, and a runway information provision system 726 that provides information relating to a state of a runway where the plane takes off and lands. It is assumed that each of the control information provision system 725 and the runway information provision system 726 is also equipped with the light receiving device according to each example embodiment. For example, the control information provision system 725 is placed at a control tower of an airfield, and the runway information provision system 726 is placed near a runway. The number of planes is not limited to two, and may be any number. A target with which the plane performs an optical space communication is not limited to the control information provision system 725 and the runway information provision system 726.

For example, when transmitting some information to the plane 722, the plane 721 sends communication light toward the plane 722. Even though the plane 722 does not accurately recognize a direction in which the signal light sent from the plane 721 arrives, the plane 722 can receive the signal light from the plane 722 as long as the signal light arrives from a direction in which light is receivable by the light receiving device. When receiving the information from the plane 721, the plane 722 responds to the received information.

For example, when transmitting information to the plane 721, the control information provision system 725 sends signal light toward the plane 721. Even though the plane 721 does not accurately recognize a direction in which the signal light sent from the control information provision system 725 arrives, the plane 721 can receive the signal light from the control information provision system 725 as long as the signal light arrives from a direction in which light is receivable by the light receiving device. The plane 721 receiving the signal light from the control information provision system 725 responds to the information of the control information provision system 725.

For example, when landing on a runway including the runway information provision system 726, the plane 721 sends signal light toward the runway information provision system 726. Even though the runway information provision system 726 does not accurately recognize a direction in which the signal light sent from the plane 721 arrives, the runway information provision system 726 can receive the signal light from the plane 721 as long as the signal light arrives from a direction in which light is receivable by the light receiving device. When having information relating to safety or the like, the runway information provision system 726 receiving the signal light from the plane 721 sends signal light including the information toward the plane 721.

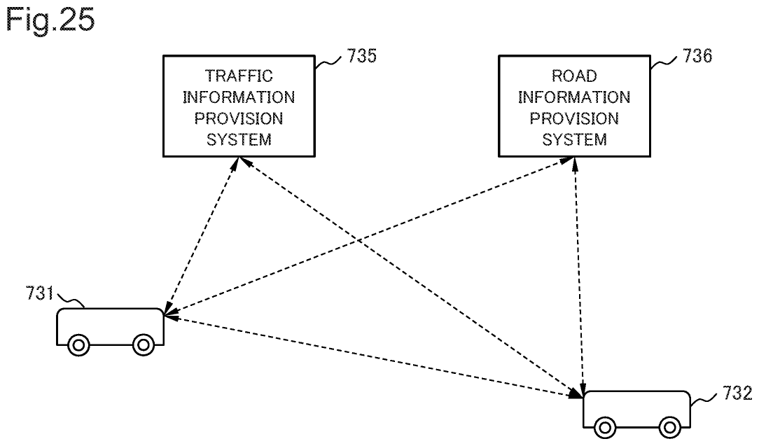

FIG. 25 is an example in which a motor vehicle is equipped with the light receiving device according to each example embodiment. FIG. 25 illustrates two motor vehicles (motor vehicles 731 and 732). FIG. 25 illustrates a traffic information provision system 735 that transmits traffic information, and a road information provision system 736 that provides information relating to a road where the motor vehicle is running. It is assumed that each of the traffic information provision system 735 and the road information provision system 736 is also equipped with the light receiving device according to each example embodiment. For example, each of the traffic information provision system 735 and the road information provision system 736 is placed on a roadside telephone pole, signal, or the like. The number of motor vehicles is not limited to two, and may be any number. A target with which the motor vehicle performs an optical space communication is not limited to the traffic information provision system 735 and the road information provision system 736.

For example, when transmitting some information to the motor vehicle 732, the motor vehicle 731 sends communication light toward the motor vehicle 732. Even though the motor vehicle 732 does not accurately recognize a direction in which the signal light sent from the motor vehicle 731 arrives, the motor vehicle 732 can receive the signal light from the motor vehicle 732 as long as the signal light arrives from a direction in which light is receivable by the light receiving device. When receiving the information from the motor vehicle 731, the motor vehicle 732 performs an operation suited to the received information.

For example, when acquiring traffic information to a destination, the motor vehicle 731 sends signal light requesting the traffic information provision system 735 to provide traffic information. Even though the traffic information provision system 735 does not accurately recognize a direction in which the signal light sent from the motor vehicle 731 arrives, the traffic information provision system 735 can receive the signal light from the motor vehicle 731 as long as the signal light arrives from a direction in which light is receivable by the light receiving device. The traffic information provision system 735 receiving the signal light from the motor vehicle 731 sends signal light including the road information toward the motor vehicle 731.

For example, when acquiring local road information relating to a road on which the motor vehicle 731 is running, the motor vehicle 731 sends signal light requesting the road information provision system 736 to provide road information. Even though the road information provision system 736 does not accurately recognize a direction in which the signal light sent from the motor vehicle 731 arrives, the road information provision system 736 can receive the signal light from the motor vehicle 731 as long as the signal light arrives from a direction in which light is receivable by the light receiving device. The road information provision system 736 receiving the signal light from the motor vehicle 731 sends signal light including the road information toward the motor vehicle 731.

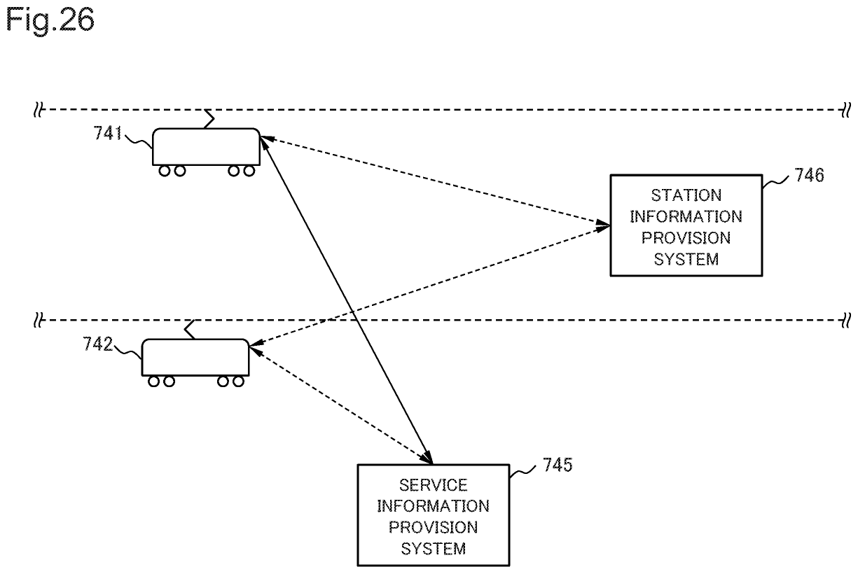

FIG. 26 is an example in which a railway vehicle is equipped with the light receiving device according to each example embodiment. FIG. 26 illustrates two railway vehicles (railway vehicles 741 and 742). FIG. 26 illustrates a service information provision system 745 that provides service information such as service status or congestion status of a railway vehicle running in the same line or in a near line, and a station information provision system 746 that provides information relating to a station which the railway vehicle stops at or passes. It is assumed that each of the service information provision system 745 and the station information provision system 746 is also equipped with the light receiving device according to each example embodiment. The number of railway vehicles is not limited to two, and may be any number. A target with which the railway vehicle performs an optical space communication is not limited to the service information provision system 745 and the station information provision system 746.

For example, when providing service information to the railway vehicle 741, the service information provision system 745 sends signal light including the service information toward the railway vehicle 741. Even though the railway vehicle 741 does not accurately recognize a direction in which the signal light sent from the service information provision system 745 arrives, the railway vehicle 741 can receive the signal light from the service information provision system 745 as long as the signal light arrives from a direction in which light is receivable by the light receiving device.

For example, when providing information on a station to the railway vehicle 741, the station information provision system 746 sends signal light including the information on the station toward the railway vehicle 741. Even though the railway vehicle 741 does not accurately recognize a direction in which the signal light sent from the station information provision system 746 arrives, the railway vehicle 741 can receive the signal light from the station information provision system 746 as long as the signal light arrives from a direction in which light is receivable by the light receiving device.

Each of the above application examples illustrated in FIGS. 23 to 26 is one example in which the light receiving device according to each example embodiment of the present invention is applied, and does not limit an application scope of the light receiving device according to each example embodiment. Any system or device with which the light receiving device according to each example embodiment communicates by an optical space communication can be equipped with the light receiving device according to each example embodiment.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

### [Supplementary Notes]

Some or all of the above-described example embodiments may be also described as, but are not limited to, the following supplementary notes.

### (Supplementary Note 1)

A light receiving device including:

a lens; and

a directional light guide board including at least a light collection area which is disposed in such a way as to face a light collection surface of the lens, and which light collected by the lens enters, a light guide area through which light entering the light collection area is guided, and an exit end from which light guided through the light guide area exits, wherein

the directional light guide board includes

a transparent light guide unit that includes a first surface facing the light collection surface of the lens, and a second surface facing the first surface, and guides, toward the exit end, light entering the light collection area from the first surface, and

a directional reflection unit which is disposed on the second surface of the transparent light guide unit, and in which a reflection structure having at least one reflection surface that reflects, toward the exit end, light entering from the first surface is formed.

### (Supplementary Note 2)

The light receiving device according to Supplementary Note 1, wherein a reflection surface of the reflection structure reflects light entering from the first surface, toward the exit end in such a way as to satisfy a total reflection condition.

### (Supplementary Note 3)

The light receiving device according to Supplementary Note 1 or 2, wherein the directional light guide board has a shape in which the light guide area is extended from the light collection area toward the exit end.

### (Supplementary Note 4)

The light receiving device according to Supplementary Note 1 or 3, wherein at least one reflection surface of the reflection structure is disposed at a focal position of the lens.

### (Supplementary Note 5)

The light receiving device according to any one of Supplementary Notes 1 to 4, wherein the reflection structure has at least one reflection unit including a reflection surface formed in such a way as to reflect, toward the exit end, light entering from the first surface in such a way as to satisfy a total reflection condition.

### (Supplementary Note 6)

The light receiving device according to any one of Supplementary Notes 1 to 5, wherein the directional light guide board has a plane mirror disposed in the light guide area between the transparent light guide unit and the directional reflection unit in such a way that a reflection surface is directed to the first surface.

### (Supplementary Note 7)

The light receiving device according to any one of Supplementary Notes 1 to 6, further including a light receiver that is disposed with a light receiving unit directed to the exit end, and that receives light exiting from the exit end and then converts the received light into an electric signal.

### (Supplementary Note 8)

The light receiving device according to Supplementary Note 7, wherein a color filter that selectively transmits light of a specific wavelength is disposed in the light receiving unit of the light receiver.

### (Supplementary Note 9)

The light receiving device according to Supplementary Note 7 or 8, further including a plurality of the light receivers.

### (Supplementary Note 10)

The light receiving device according to Supplementary Note 9, wherein a color filter that selectively transmits light of a specific wavelength is disposed in a light receiving unit of each of a plurality of the light receivers.

### (Supplementary Note 11)

The light receiving device according to Supplementary Note 9, further including a color separation means, disposed between the exit end and the light receiver, for selectively color-separating light exiting from the exit end.

### (Supplementary Note 12)

The light receiving device according to Supplementary Note 11, wherein the color separation means

includes at least one dichroic mirror that selectively reflects or transmits light in at least one wavelength region out of light exiting from the exit end, and

each of a plurality of the light receivers

is disposed in such a way as to receive at least any of reflected light or transmitted light of at least one of the dichroic mirror.

### (Supplementary Note 13)

The light receiving device according to Supplementary Note 9, wherein a plurality of the light receivers

are disposed in such a way that light receiving directions are different from one another according to a travel direction of light guided through the light guide area.

### (Supplementary Note 14)

The light receiving device according to any one of Supplementary Notes 1 to 13, wherein the directional light guide board

is foldable in at least a part of the light guide area.

### (Supplementary Note 15)

The light receiving device according to any one of Supplementary Notes 7 to 14, wherein the directional light guide board

is foldable in at least a part of the light guide area, and

the light receiver

is mounted on the first surface of the directional light guide board by folding at least a part of the light guide area.

### (Supplementary Note 16)

The light receiving device according to Supplementary Note 14 or 15, further including a foldable reflecting mirror disposed in at least a part of the first surface of a foldable portion of the light guide area in such a way that a reflection surface is directed to the first surface.

### (Supplementary Note 17)

A directional light guide board including at least a light collection area which is disposed in such a way as to face a light collection surface of a lens, and which light collected by the lens enters, a light guide area through which light entering the light collection area is guided, and an exit end from which light guided through the light guide area exits, the directional light guide board further including:

a transparent light guide unit that includes a first surface facing the light collection surface of the lens, and a second surface facing the first surface, and guides, toward the exit end, light entering the light collection area from the first surface; and

a directional reflection unit which is disposed on the second surface of the transparent light guide unit, and in which a reflection structure having at least one reflection surface that reflects, toward the exit end, light entering from the first surface is formed.

### REFERENCE SIGNS LIST

1, 2, 3, 4, 5, 6 Light receiving device
11, 21, 31, 61 Lens
12, 22, 32, 42, 52, 62 Directional light guide board
13, 23, 33, 63 Reflection structure
15, 25, 35, 45, 55, 65 Light receiver
36 Color filter
46, 47 Color separation unit
121, 221, 321 Transparent light guide unit
123, 223, 323 Directional reflection unit
130, 230, 330 Reflecting mirror
241 Plane mirror
351, 451 First light receiver
352, 452 Second light receiver
353, 453 Third light receiver
361 First filter
362 Second filter
363 Third filter
461, 471 First mirror
462, 472 Second mirror
463, 473 Third mirror
466, 476 First lens
467, 477 Second lens
468, 478 Third lens

1. A light receiving device comprising:
a lens; and
a directional light guide board including at least a light collection area which is disposed in such a way as to face a light collection surface of the lens, and which light collected by the lens enters, a light guide area through which light entering the light collection area is guided, and an exit end from which light guided through the light guide area exits, wherein
the directional light guide board includes
a transparent light guide unit that includes a first surface facing the light collection surface of the lens, and a second surface facing the first surface, and guides, toward the exit end, light entering the light collection area from the first surface, and
a directional reflection unit which is disposed on the second surface of the transparent light guide unit, and in which a reflection structure having at least one reflection surface that reflects, toward the exit end, light entering from the first surface is formed.

2. The light receiving device according to claim 1, wherein a reflection surface of the reflection structure reflects light entering from the first surface, toward the exit end in such a way as to satisfy a total reflection condition.

3. The light receiving device according to claim 1, wherein the directional light guide board
has a shape in which the light guide area is extended from the light collection area toward the exit end.

4. The light receiving device according to claim 1, wherein at least one reflection surface of the reflection structure is disposed at a focal position of the lens.

5. The light receiving device according to claim 1, wherein the reflection structure
has at least one reflection unit including a reflection surface formed in such a way as to reflect, toward the exit end, light entering from the first surface in such a way as to satisfy a total reflection condition.

6. The light receiving device according to claim 1, wherein the directional light guide board
has a plane mirror disposed in the light guide area between the transparent light guide unit and the directional reflection unit in such a way that a reflection surface is directed to the first surface.

7. The light receiving device according to claim 1, further comprising a light receiver that is disposed with a light receiving unit directed to the exit end, and that receives light exiting from the exit end and then converts the received light into an electric signal.

8. The light receiving device according to claim 7, wherein a color filter that selectively transmits light of a specific wavelength is disposed in the light receiving unit of the light receiver.

9. The light receiving device according to claim 7, further comprising a plurality of the light receivers.

10. The light receiving device according to claim 9, wherein a color filter that selectively transmits light of a specific wavelength is disposed in a light receiving unit of each of a plurality of the light receivers.

11. The light receiving device according to claim 9, further comprising a color separation unit, disposed between the exit end and the light receiver, for selectively color-separating light exiting from the exit end.

12. The light receiving device according to claim 11, wherein the color separation unit
includes at least one dichroic mirror that selectively reflects or transmits light in at least one wavelength region out of light exiting from the exit end, and
each of a plurality of the light receivers
is disposed in such a way as to receive at least any of reflected light or transmitted light of at least one of the dichroic mirror.

13. The light receiving device according to claim 9, wherein a plurality of the light receivers
are disposed in such a way that light receiving directions are different from one another according to a travel direction of light guided through the light guide area.

14. The light receiving device according to claim 1, wherein the directional light guide board
is foldable in at least a part of the light guide area.

15. The light receiving device according to claim 7, wherein the directional light guide board
is foldable in at least a part of the light guide area, and
the light receiver
is mounted on the first surface of the directional light guide board by folding at least a part of the light guide area.

16. The light receiving device according to claim 14, further comprising a foldable reflecting mirror disposed in at least a part of the first surface of a foldable portion of the light guide area in such a way that a reflection surface is directed to the first surface.

17. A directional light guide board comprising at least a light collection area which is disposed in such a way as to face a light collection surface of a lens, and which light collected by the lens enters, a light guide area through which light entering the light collection area is guided, and an exit end from which light guided through the light guide area exits, the directional light guide board further comprising:
a transparent light guide unit that includes a first surface facing the light collection surface of the lens, and a second surface facing the first surface, and guides, toward the exit end, light entering the light collection area from the first surface; and
a directional reflection unit which is disposed on the second surface of the transparent light guide unit, and in which a reflection structure having at least one reflection surface that reflects, toward the exit end, light entering from the first surface is formed.

18. The light receiving device according to claim 2, wherein the directional light guide board
has a shape in which the light guide area is extended from the light collection area toward the exit end.

19. The light receiving device according to claim 2, wherein the reflection structure
has at least one reflection unit including a reflection surface formed in such a way as to reflect, toward the exit end, light entering from the first surface in such a way as to satisfy a total reflection condition.

20. The light receiving device according to claim 2, wherein the directional light guide board
has a plane mirror disposed in the light guide area between the transparent light guide unit and the directional reflection unit in such a way that a reflection surface is directed to the first surface.
